(19) United States
(12) Patent Application Publication
(10) Pub. No.: US 2021/0307979 A1
(43) Pub. Date: Oct. 7, 2021

(54) Swingback Wheelchair for easy transfer of patients.

(71) Applicant: Carrie Mabe, Brashear, TX (US)

(72) Inventor: Carrie Mabe, Brashear, TX (US)

(21) Appl. No.: 16/839,109

(22) Filed: Apr. 3, 2020

(51) Int. Cl. A61G 5/10; A61G 5/12

(52) U.S. Cl. CPC A61G 5/10; A61G 5/125; A61G 5/128; A61G 5/127

(57) ABSTRACT

Swingback wheelchair is used to transfer non-weight bearing patient, or physically challenged person from back of wheelchair/transport chair instead of over the arm of chair by unlocking back strap of chair. The ease of transfer will enhance quality of life, maintain personal dignity by requiring less staff or family members to be involved. Making for more independence and bringing less attention to the disability, which in turn would improve self-esteem, moral, mental state of the individual. Helping to make the person with the disability to feel more like a human being.

A device for assisting a handicapped person from a wheelchair or transport chair. Swing back wheelchairs or transport chairs will allow the handicapped person to be moved from the chair to an X-Ray table, toilet, bed or any other object without being lifted over the side of the chair. Simply unlock the back of the chair to slide the person out of the back of the chair onto object. Making for fewer persons to transfer and less assistance from staff or family and less pain during transfer.

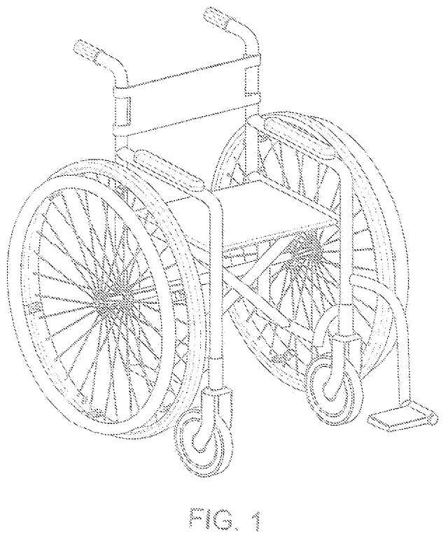

FIG. 1

Standard wheelchair, showing chair in its normal condition with swingback locked.

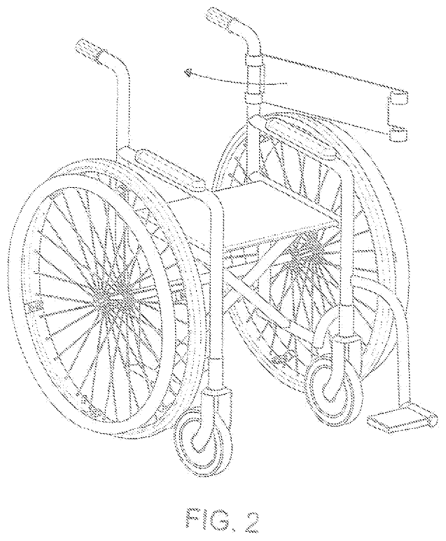

FIG. 2

Standard wheelchair with swingback open to prepare for transfer.

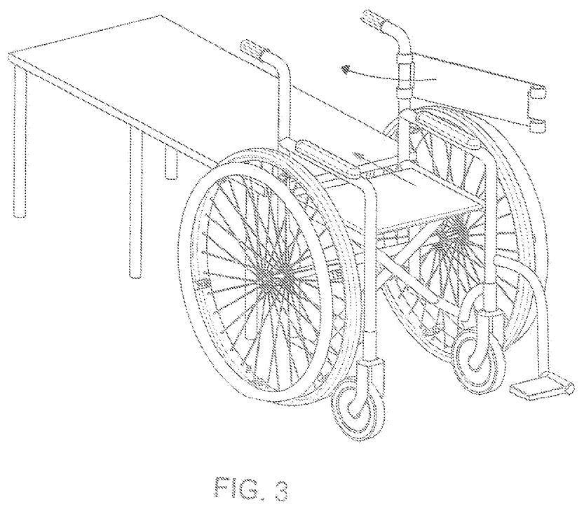

FIG. 3

Showing standard wheelchair in position to a table to be able to slide patient onto table without lifting over wheel or arm of chair and less assistance needed for transfer.

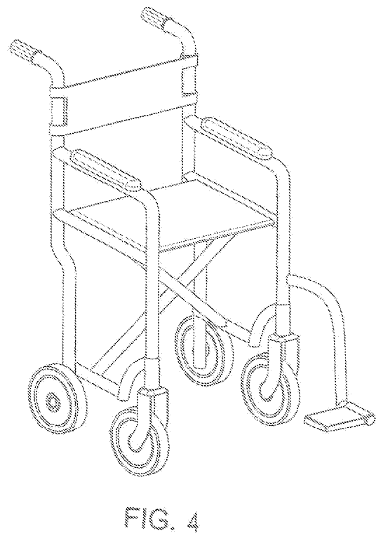

FIG. 4

Standard transport chair, showing chair in its normal condition with swingback locked.

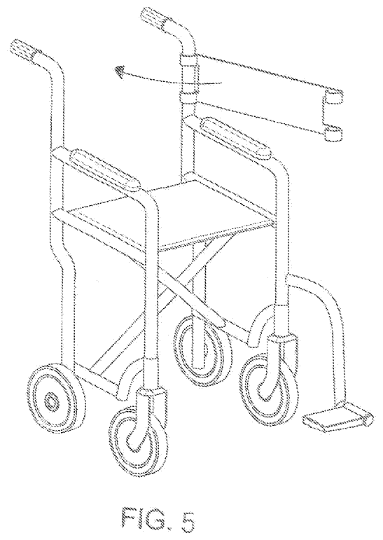

FIG. 5

Standard transport chair with swingback open to prepare for transfer.

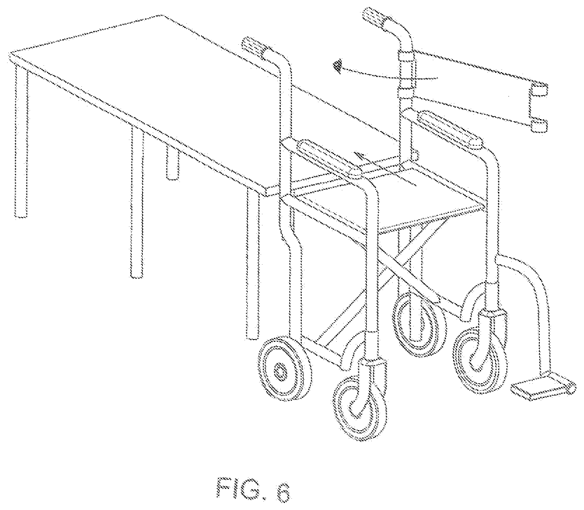

FIG. 6

Showing standard transport chair in position to a table to be able to slide patient onto table without lifting over wheel or arm of chair and less assistance needed for transfer.

1. A swingback wheelchair comprising: footrest, legrest, front rigging, frame, seat, metal skirt, armrests, backrest, push handles, push axle, rear wheels, handrims, brakes, tipping lever, crossbars, caster wheels, anti-tip casters, wherein the backrest is connected to the push handles; wherein said backrest will detach from push handles to open back of wheelchair to transfer patient from chair to object.
